(19) United States
(12) Patent Application Publication
(10) Pub. No.: US 2008/0105371 A1
(43) Pub. Date: May 8, 2008

(54) Decorative Laminated Safety Glass Utilizing a Rigid Interlayer and a Process for Preparing Same

(75) Inventors: Rebecca L. Smith, Vienna, WV (US); Hamdy A. Elwakil, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 11/971,781

(22) Filed: Jan. 9, 2008

Related U.S. Application Data
(62) Division of application No. 10/913,714, filed on Aug. 6, 2004.
(60) Provisional application No. 60/493,258, filed on Aug. 7, 2003.

(51) Int. Cl. B32B 38/14; B05D 1/02; B41F 31/00

(52) U.S. Cl. 156/277; 427/421.1; 101/491

(57) ABSTRACT

The present invention is process for preparing a decorative glass laminate comprising a rigid interlayer comprising printing an image onto at least one of the interlayer surfaces.

This application is a divisional of Ser. No. 10/913,714, filed Aug. 6, 2004, which is incorporated herein by reference, and which claims the benefit of U.S. Provisional Application No. 60/493,258, filed Aug. 7, 2003.

### BACKGROUND OF THE INVENTION

Laminated safety glass consists of two lites of glass joined by an energy absorbing plastic interlayer, typically polyvinylbutyral (PVB). Laminated safety glass is used in automotive windshields and in architectural building glass. Architects are continually using glass in more demanding applications such as balustrades, partitions, floors, doors, and overhead bolted glass. Laminated safety glass using plasticized PVB as the interlayer typically does not meet the strength or post glass breakage requirements for these applications. Specially designed ionomers of ethylene/methyacrylic acid copolymers (available from E. I. du Pont de Nemours and Company) yield interlayer materials that are rigid, much stiffer and tougher than traditional PVB interlayers. Laminated safety glass utilizing stiffer, tougher interlayer has been shown to possess the strength and post glass breakage requirements needed for these demanding architectural applications.

In addition, it has been found that interlayers of specially designed ionomeric ethylene/methyacrylic acid copolymers demonstrate much improved edge stability over traditional PVB interlayers. This improved edge stability allows for laminated glass (with interlayers of ionomeric ethylene/methyacrylic acid copolymers) to be used in applications such as shower doors and exterior open edge applications where traditional laminated glass (with, for example, PVB interlayers) would not be used. In many of these above-mentioned applications (balustrades, partitions, floors, doors, overhead bolted glass, and shower doors) it can be desirable to have a decorative image in the laminated safety glass.

Processes for making laminated decorative glass have been disclosed in WO 217154A1, DE 29706880, U.S. Pat. No. 4,968,553, U.S. Pat. No. 5,914,178, EP 1129844A1, and DE 20100717. These decorative laminates use PVB, PVB/PET/PVB composites, or EVA (ethylene/vinyl acetate copolymers) as the interlayer. While the resulting decorative safety glass laminates may meet the architectural safety codes, these laminates may not perform well in demanding applications such as those outlined above.

Further many of these references disclose a process for making decorative laminated glass via a silk screening process (DE 29706880, U.S. Pat. No. 4,968,553, U.S. Pat. No. 5,914,178, EP 1129844A1, and DE 20100717). Silk-screening an image onto an interlayer is a very time-consuming and expensive process for making decorative laminated safety glass. Ink jet technology is very flexible; any digital image can be printed onto the substrate. Using ink jet technology to print on flexible interlayers (PVB and polyurethanes) for laminated safety glass has been disclosed in WO 0218154. Several disadvantages of ink jet printing directly on PVB include the fact that all PVB interlayers have a roughened surface pattern (Rz from 30-60 μm), which is present to allow for air to escape during the lamination process as described in U.S. Pat. No. 5,455,103. The rough surface pattern can affect image quality with respect to mottle and resolution. Also, polyvinyl butyral, for example, is a viscoelastic polymer which can lead to poor dimensional stability in the image-bearing interlayer.

Interlayers obtained from specially designed ionomers of ethylene/methyacrylic acid copolymers are stiff relative to other conventional interlayers, and can have improved dimensional stability relative to PVB, for example. However, the Applicants have found that one problem with printing on a stiff polymeric material is that a stiff polymer is not completely amenable to conventional printing processes for which there are printers and inks that are readily available for use. The Applicants have found that the process of ink jet printing on a conventional ionomeric interlayer using a conventional ink jet printer is problematical because an ionomer of ethylene/methyacrylic acid copolymer is not flexible enough to be fed through many conventional ink jet printers.

### SUMMARY OF THE INVENTION

In one aspect, the present invention is a process for ink-jet printing an image onto a rigid thermoplastic interlayer comprising the step: feeding a rigid interlayer sheet through an ink jet printer and ink-jet printing an image on the sheet, wherein the interlayer has a Storage Young's Modulus of 50-1,000 MPa (mega Pascals) at 0.3 Hz and 25° C., as determined according to ASTM D 5026-95a.

In another aspect, the present invention is a thermoplastic interlayer sheet bearing an image on at least one surface of the interlayer sheet, the image being printed on the sheet by a process comprising the step: feeding a rigid interlayer sheet through an ink jet printer and ink-jet printing an image on the sheet, wherein the interlayer has a Storage Young's Modulus of 50-1,000 MPa (mega Pascals) at 0.3 Hz and 25° C., as determined according to ASTM D 5026-95a.

The invention is also directed to a process for obtaining a decorative laminate having a laminate adhesive strength of at least about 1000 psi, the process comprising the steps: (1) “ink jet” printing pigmented ink onto at least one surface of an interlayer sheet, wherein the interlayer has a thickness of 60 mils (1.524 mm) or less and a Storage Young's Modulus of from about 100 MPa (mega Pascals) to about 1,000 MPa at 0.3 Hz and 25° C., as determined according to ASTM D 5026-95a, to obtain an image-bearing interlayer sheet; and (2) laminating the image-bearing interlayer sheet between sheets of transparent materials to obtain a decorative laminate, wherein the pigments comprise at least one pigment selected from the group consisting of PY 139; PY 120; PY 155; PY 14; PY 110; PY 128; PY 180; PY 95; PY 93; PV19/PR 202; PR 122; PB 15:4; PB 15:3; and PBI 7. Preferably the rigid interlayer comprises a copolymer ionomer of either ethylene and methacrylic acid or ethylene and acrylic acid. The invention is also directed to a decorative laminate obtained by the above process and having a compressive shear strength of at least 1000 psi. Preferably the image-bearing interlayer is laminated with at least one additional sheet of at least one other interlayer to produce a composite image-bearing interlayer, wherein the at least one additional interlayer sheet has a thickness sufficient to such that the total thickness of the composite interlayer falls within a range of from about 0.40 mm to about 2.29 mm, and wherein the composite image-bearing interlayer is further laminated with at least one sheet of glass.

In a preferred embodiment of the process described in the preceding paragraph, the image-bearing interlayer has a thickness of less than or equal to about 0.38 mm and wherein the image-bearing interlayer is laminated with one or more other interlayer sheets to yield a composite interlayer having a total thickness of from about 0.40 mm to about 2.29 mm. Preferably the other interlayer comprises a thermoplastic polymer selected from polymers in the group consisting of: PVB; PET; PUR; PC; PVC; of ethylene/(meth)acrylic acid copolymer ionomers; ethylene/(meth)acrylic acid/alkyl acrylates terpolymers. Preferably the image is printed using a drop on demand (DOD) ink jet printing process. In one preferred embodiment, the DOD process is a piezo electric process. In another preferred embodiment, the DOD process is a thermal ink jet printing process, and preferably the image is printed using a continuous drop ink jet printing process.

In still another aspect, the present invention is a decorative glass laminate comprising at least two sheets of glass having disposed therebetween a rigid image-bearing interlayer sheet wherein the image bearing interlayer was obtained by a process comprising the steps of: (1) “ink jet” printing pigmented ink onto at least one surface of an interlayer sheet which is a rigid ethylene/methyacrylic acid copolymer ionomer having a thickness of less than or equal to about 0.38 mm and wherein the interlayer has a Storage Young's Modulus of 50-1,000 MPa (mega Pascals) at 0.3 Hz and 25° C., as determined according to ASTM D 5026-95a, to obtain an image-bearing interlayer sheet; and (2) laminating the image-bearing interlayer sheet between sheets of transparent materials to obtain a decorative laminate.

In another aspect, the present invention is a thermoplastic interlayer sheet bearing an image on at least one surface of the interlayer sheet, wherein the image-bearing interlayer has a Storage Young's Modulus of 50-1,000 MPa (mega Pascals) at 0.3 Hz and 25° C., as determined according to ASTM D 5026-95a.

In still another aspect, the present invention is a decorative laminate comprising a rigid interlayer sheet bearing an image on at least one surface of the interlayer sheet, wherein the interlayer has a Storage Young's Modulus of 50-1,000 MPa (mega Pascals) at 0.3 Hz and 25° C., as determined according to ASTM D 5026-95a. Preferably the laminate comprises at least one sheet of glass. In a preferred embodiment, the laminate comprises at least two sheets of glass. Preferably the image-bearing interlayer has a thickness of 60 mils (1.524 mm) or less. More preferably the image-bearing interlayer has a thickness of 0.38 mm or less. Preferably the interlayer is a composite interlayer comprising the image-bearing interlayer and at least one additional interlayer sheet, wherein the total thickness of the composite interlayer is from about 0.40 mm to about 2.29 mm.

The invention is also directed to a process for printing an image onto a rigid thermoplastic interlayer substrate, comprising the step of printing at least one ink onto the surface of the thermoplastic substrate, and wherein the at least one ink comprises a UV curable ink to print on the thermoplastic substrate, and wherein the interlayer has a Storage Young's Modulus of from about 100 MPa (mega Pascals) to about 1,000 MPa at 0.3 Hz and 25° C., as determined according to ASTM D 5026-95a, to obtain an image-bearing interlayer sheet. Preferably the printing process is either: ink jet printing or screen printing.

The invention is further directed to an article comprising a decorative laminate that comprises a rigid interlayer sheet bearing an image on at least one surface of the interlayer sheet, wherein the interlayer has a Storage Young's Modulus of 50-1,000 MPa (mega Pascals) at 0.3 Hz and 25° C., as determined according to ASTM D 5026-95a. Preferably the article is an article is selected from articles in the group consisting of: vehicles used for transportation by land, by air or by waterway; architectural structural elements; furniture; picture frames; signage; billboards; storefront windows; artwork; and decorative accessories.

### DETAILED DESCRIPTION OF THE INVENTION

In one embodiment, this invention is a decorative image-bearing rigid interlayer. A rigid interlayer suitable for use in the practice of the present invention preferably has a Storage Young's Modulus of 50-1,000 MPa (mega Pascals) at 0.3 Hz and 25° C., as determined according to ASTM D 5026-95a. Other conventional interlayer materials can be suitable as a substrate for ink-jet printing, but there are advantages in using a rigid interlayer material.

Rigid, stiff Interlayers, such as those based upon specially designed ionomeric ethylene/methyacrylic acid copolymers or stiff (low plasticized) PVB, facilitate using a much smoother surface pattern to obtain acceptable deairing during lamination since the surface pattern does not break down as rapidly with a rigid interlayer. For example, a desirable range of Rz for laminating conventionally plasticized (flexible) PVB is 30-60 μm while an acceptable range of Rz for stiff interlayers is from 5 to 15 μm. The smooth surface pattern for the ionomeric interlayer yields printed images with higher resolution and less mottle than images printed directly on PVB.

The higher modulus of a rigid interlayer relative to other conventional flexible interlayer materials, such as flexible PVB, can yield an interlayer that has improved dimensional stability versus more flexible materials. The improved dimensional stability can improve the image stability of the image-bearing product, and make the entire process more reliable and reproducible with respect to elongation or shrinkage of the image.

Printing on a rigid interlayer to obtain an image-bearing rigid interlayer can be accomplished using either an aqueous or solvent based ink, and using conventional printing techniques such as screen printing or ink jet printing, and laminating the image bearing rigid interlayer between two lites of glass or other transparent materials. Using conventional printing methods on rigid polymeric printing substrates is not conventional because of the requirement to use specialized printing inks, printing equipment, and printing procedures to obtain images of good quality.

In a preferred embodiment, an image is printed onto a rigid interlayer using an inkjet printer equipped with a piezoelectric drop on demand printhead such as Spectra or Xaar and the inkjet printer is chosen so that the rigid interlayer is held on a bed type support.

The interlayer can be any clear, transparent rigid thermoplastic material that can be adhesively bonded to glass. The interlayer, for example, can be a PVB sheet having less than 30 parts of plasticizer, or an ionomeric interlayer. The interlayer is preferably an ionomer of an ethylene/(meth)acrylic acid copolymer where the surface roughness (Rz) of the sheet is between 5 and 15 μm and the total thickness of the interlayer is between 0.38-2.29 mm. The interlayer can be a single interlayer sheet or a combination of several layers of interlayer combined to provide a composite interlayer. If a single sheet, the interlayer printing substrate sheet is preferably 60 mils (1.524 mm) or less to enable conventional ink-jet printing equipment to accommodate the high modulus of the material. More preferably a single rigid interlayer printing substrate sheet is 0.38 mm or less. The thinner sheets can be preferred because currently more of the conventional printing equipment can accommodate thinner sheets of printing substrate materials having high modulus than are available to accommodate thicker sheets of the high modulus (rigid) materials.

The term “ethylene/(meth)acrylic acid” as used herein is a shorthand term that denotes a copolymer that comprises either ethylene and acrylic acid units or ethylene and methacrylic acid units. Ionomers are known conventionally as partially neutralized ethylene/(meth)acrylic acid copolymers. A suitable interlayer for printing according to the practice of the present invention can be obtained using specially designed ethylene/acrylic acid copolymer ionomers, commercially available from E. I. du Pont de Nemours and Company, for example.

In another embodiment, the present invention is a composite image-bearing interlayer which can be obtained by a process comprising the step of feeding a thin substrate film having Storage Young's Modulus of 50-1,000 MPa at 0.3 Hz and 25° C., as determined according to ASTM D 5026-95a, and having a finite thickness less than or equal to about 0.38 mm, through a conventional ink jet printer and ink-jet printing an image onto the surface of the substrate film, and then laminating the image-bearing thin film with a second sheet of a thermoplastic interlayer material. The composite printed interlayer preferably has a thickness of from about 0.40 to about 2.29 mm. The thickness of the other sheets can vary, but should be at least 0.025 mm thick. The other sheets can be blank, bear printed images or colors, can be transparent, semi-transparent, opaque or can otherwise be visually distinct from the printing substrate. In a preferred embodiment the thin printing substrate can be laminated with a thicker (≧0.76 mm) film or sheet of, for example, an ionomer of an ethylene/methylacrylic acid copolymer to achieve the desired structural properties in the finished laminate. Lamination of the image-bearing interlayer sheet with a thicker polymer sheet yields a product having an image imprinted on the interlayer and also having the properties of a thicker interlayer.

The other sheet can be any thermoplastic interlayer material that can be adhesively bonded to the printed ionomer film. For example, the thicker film can be: an ethylene copolymer and/or terpolymer such as ethylene/acrylic acid or ethylene/alkyl acrylate copolymers and ethylene/acrylic acid/alkyl acrylate terpolymers; a polyacetal; a polyvinylbutyral; a polyurethane; a polyvinyl chloride; or, a polyester.

While some printers can accommodate a sheet of rigid sheeting of up to about 60 mils (1.52 mm) thickness, it can be preferred to use thinner sheets for most other printers. Preferably the thin substrate film has a thickness in the range of from about 0.025 mm to about 1.52 mm. More preferably, the thickness of the printing substrate is from about 0.1 mm to about 0.40 mm. Most preferably, the thickness of the printing substrate is from about 0.25 mm to about 0.38 mm. The thicker film sheet preferably has a thickness that is complimentary to the thickness of the thin film such that the total thickness of the interlayer sheets is in the range of from about 0.38 mm to about 2.29 mm. More preferably, the total thickness is in the range of from about 0.60 mm to about 1.75 mm. Most preferably, the total thickness of the interlayer is from about 1.14 mm to about 1.55 mm.

Laminates of the present invention can be used in any application wherein conventional (that is, non-decorative) laminated glass is used. In addition to the conventional uses as safety glass, however, the laminates of the present invention can be used as decorative articles such as picture windows, decorative countertops, graphic art, image-bearing store-front windows, displays bearing company logos, advertising media, and/or any other use wherein a transparent laminate bearing an image can be desirable. A decorative image, for the purposes of the present invention, is any image that is printed onto the surface of a substrate according to the process described herein. An image can be graphical, textual, photographic, pictorial, abstract design, a single color and/or any combination of colors—which for the purposes of the present invention is inclusive of black and white—or any combination of various types of images.

Preferable inks for use in the practice of the present invention are those that provide printed images having a satisfactory combination of image quality, light fastness, and weatherability. Further, laminates that incorporate image-bearing interlayers of the present invention should have the adhesion properties that are acceptable in the various applications in which they will be used. Due to the nature of the polymeric interlayer substrates used herein for printing, and the requirements for adhesion in a safety glass, choice of a suitable ink is not problem free. Ink suitable for use in the practice of the present invention must also be compatible with the substrate to give satisfactory results.

Printing heads useful for piezo electric processes are available from, for example, Epson, Seiko-Epson, Spectra, XAAR and XAAR-Hitachi. Printing heads useful for thermal ink jet printing are available from, for example, Hewlett-Packard and Canon. Printing heads suitable for continuous drop printing are available from Iris and Video Jet, for example.

Optionally included in an ink system suitable for use in the practice of the present invention is a binder resin. A binder resin can be preferable to improve adhesion between the ink and the laminate substrate. Suitable binders for use in the practice of the present invention can include polyvinyl pyrilidone/vinyl acetate (PVP/VA), polyvinyl pyrilidone (PVP), and PUR, for example. Mixtures of binder resins can also be useful in the practice of the present invention. Other binders are conventionally known and can be useful herein.

Laminates of the present invention can be useful as an architectural structural element in various architectural applications such as, for example, glazing, structural supports, walls, stairs, balustrades, partitions, floors, ceilings, and doors—including shower stall doors. Laminates of the present invention can be useful in vehicles used for ground transportation such as: automobiles, which for the purposes of the present invention include trucks, vans, sports utility vehicles (SUVs), busses, and cars; motorcycles; farm vehicles; construction vehicles; vehicles used in excavation; trains, including subway cars, commuter trains, elevated trains passenger trains, and freight trains, for example. Laminates of the present invention can be useful in vehicles used for air transportation, such as: airplanes, including commercial passenger planes, non-commercial planes, military planes, small planes, jets, helicopters, un-manned (robotic) planes; and remote controlled guided planes, for example. Laminates of the present invention can be useful in vehicles used for waterway transportation such as: motorized boats, sailboats, oceanliners, military boats, and submarines, for example. In a vehicle, laminates of the present invention can be useful as windshields, side windows, external or internal light covers, body panels, flooring, roofing such as sunroofs/moonroofs, and instrument panel covers, for example. Laminates of the present invention can be useful in other applications as well, such as: furniture, including tabletops, cabinetry, desktops, credenzas; picture frames; signage; billboards; storefront windows; as artwork; as decorative accessories to rooms or offices. The laminates of the present invention can be useful in most if not all applications where glass and/or glass laminates can be useful, and can be desirable due to the functional use of the images displayed on the interlayer, as well as or alternatively because of the non-functional use of the image displayed on the interlayer.

### EXAMPLES

The following examples are presented to illustrate the invention. The examples are not intended to limit the scope of the invention in any manner.

Test Methods

Surface Roughness, Rz, is determined from the 10 point average roughness as described in ISO-R468 and is expressed in microns. Surface roughness is measured using a Mahr Federal (Providence, R1) surfanalyzer.

Lamination, An image was printed onto the surface of 15 mil (0.38 mm) thick interlayer via an ink-jet printer. Prior to lamination the sheeting layers were dried to less than 0.2% H₂O using a 75° C. oven for a minimum of 16 hours. For lamination, a layer of 15 mil clear interlayer was placed on the image bearing surface. The multi-layered structure was deaired (by either a vacuum bag or nip roll process) and autoclaved using standard lamination conditions.

### Example 1

A solid yellow color block was printed onto the surface of a 0.38 mm thick interlayer of an ionomer of ethylene/methylacrylic acid copolymer using an Epson 3000 printer. The ink used is described in the table below. The printed interlayer was laminated as described above.

| | |
|---|---|
| Dispersion | Acrylic polymer |
| | Pigment Yellow 120 |
| | Dipropylene glycol monomethyl ether |
| Binder | Khrumbhaar 1717 |
| Solvents | Dipropylene glycol methyl ether acetate |
| | DPnP |

### Example 2

A solid yellow color block was printed and laminated as described in Example 1. The ink used is described in the table below.

| | |
|---|---|
| Dispersion | Acrylic polymer |
| | Pigment Yellow 120 |
| | Dipropylene glycol monomethyl ether |
| Binder | Khrumbhaar 3107 |
| Solvents | Dipropylene glycol methyl ether acetate |
| | DPnP |

### Example 3

A solid yellow color block was printed and laminated as described in Example 1. The ink used is described in the table below.

| | |
|---|---|
| Dispersion | Acrylic polymer |
| | Pigment Yellow 120 |
| | Dipropylene glycol monomethyl ether |
| Binder | Khrumbhaar 1728 |
| Solvents | Dipropylene glycol methyl ether acetate |
| | DPnP |

### Example 4

A solid yellow color block was printed and laminated as described in Example 1. The ink used is described in the table below.

| | |
|---|---|
| Dispersion | Acrylic polymer |
| | Pigment Yellow 120 |
| | Dipropylene glycol monomethyl ether |
| Binder | Laropal 80 |
| Solvents | Dipropylene glycol methyl ether acetate |
| | DPnP |

### Example 5

A solid yellow color block was printed and laminated as described in Example 1. The ink used is described in the table below.

| | |
|---|---|
| Dispersion | Acrylic polymer |
| | Pigment Yellow 120 |
| | Dipropylene glycol monomethyl ether |
| Binder | Laropal 81 |
| Solvents | Dipropylene glycol methyl ether acetate |
| | DPnP |

### Example 6

A solid yellow color block was printed and laminated as described in Example 1. The ink used is described in the table below.

| | |
|---|---|
| Dispersion | Acrylic polymer |
| | Pigment Yellow 120 |
| | Dipropylene glycol monomethyl ether |
| Binder | Laropal A101 |
| Solvents | Dipropylene glycol methyl ether acetate |
| | DPnP |

### Example 7

SunJet® inks, UV curable inks commercially available from Sun Chemical, were coated on the surface of a 60 mils thick ethylene acid copolymer ionomer substrate using rod #6 on a JV3 printer. The coated substrate was then passed under a UV curing station (obtained from Fusion UV Systems, Inc.) at a speed of 16 feet/minute, using a UV lamp of 300 watts per linear inch. The inks were found to dry instantaneously with good laminate adhesion.

What is claimed is:

1. A process for obtaining a decorative laminate having a laminate adhesive strength of at least about 1000 psi, the process comprising the steps: (1) ink jet printing pigmented ink onto at least one surface of an interlayer sheet comprising a copolymer ionomer of ethylene and methacrylic acid or copolymer ionomer of ethylene and acrylic acid, wherein the interlayer has a thickness of 60 mils or less and a Storage Young's Modulus of from about 100 MPa to about 1,000 MPa at 0.3 Hz and 25° C., as determined according to ASTM D 5026-95a, to obtain an image-bearing interlayer sheet; and (2) laminating the image-bearing interlayer sheet between sheets of transparent materials to obtain a decorative laminate, wherein the pigmented ink comprises at least one pigment selected from the group consisting of PY 139; PY 155; PY 14; PY 110; PY 128; PY 180; PY 95; PY 93; PV1 g/PR 202; PR 122; PB 15:4; PB 15:3; and PBI 7.

2. The process of claim 1 wherein the image-bearing interlayer has a thickness of about 0.025 mm to about 1.52 mm.

3. The process of claim 1 wherein the image-bearing interlayer has a thickness of about 0.25 mm to about 0.38 mm.

4. The process of claim 1 wherein the sheets of transparent material are glass sheets.

5. The process of claim 3 wherein the sheets of transparent material are glass sheets.

6. The process of claim 1 wherein the image-bearing interlayer has a thickness of less than or equal to about 0.38 mm and wherein the image-bearing interlayer is laminated with one or more other interlayer sheets to yield a composite interlayer having a total thickness of from about 0.40 mm to about 2.29 mm.

7. The process of claim 6 wherein the other interlayer comprises a thermoplastic polymer selected from polymers in the group consisting of: polyvinylbutyral; polyurethane; ethylene/acrylic acid copolymer ionomers; ethylene/(meth)acrylic acid copolymer ionomers; and ethylene/(meth)acrylic acid/alkyl acrylates terpolymers.

8. The process of claim 1 wherein the image is printed using a drop on demand ink jet printing process.

9. The process of claim 8 wherein the drop on demand process is a piezo electric process.

10. The process of claim 8 wherein the drop on demand process is a thermal ink jet printing process.

11. The process of claim 10 wherein the thermal ink jet printing process is a continuous drop ink jet printing process.

12. The process of claim 1 wherein the surface roughness (Rz) of the surface of the interlayer sheet that is printed on is between 5 and 15 μm.

13. A process for printing an image onto a rigid thermoplastic interlayer sheet comprising a copolymer ionomer of ethylene and methacrylic acid or copolymer ionomer of ethylene and acrylic acid, comprising the step of printing at least one ink onto the surface of the thermoplastic substrate, and wherein the at least one ink comprises a UV curable ink to print on the thermoplastic substrate, and wherein the interlayer has a Storage Young's Modulus of from about 100 MPa (mega Pascals) to about 1,000 MPa at 0.3 Hz and 25° C., as determined according to ASTM D 5026-95a, to obtain an image-bearing interlayer sheet.

14. The process of claim 13 wherein the printing process is either: ink jet printing or screen printing.

15. The process of claim 12 wherein the image-bearing interlayer has a thickness of about 0.025 mm to about 1.52 mm.

16. The process of claim 12 wherein the image-bearing interlayer has a thickness of about 0.25 mm to about 0.38 mm.

17. The process of claim 12 wherein the sheets of transparent material are glass sheets.

18. The process of claim 16 wherein the sheets of transparent material are glass sheets.

19. The process of claim 13 wherein the image-bearing interlayer has a thickness of less than or equal to about 0.38 mm and wherein the image-bearing interlayer is laminated with one or more other interlayer sheets to yield a composite interlayer having a total thickness of from about 0.40 mm to about 2.29 mm.

20. The process of claim 19 wherein the other interlayer comprises a thermoplastic polymer selected from polymers in the group consisting of: polyvinylbutyral; polyurethane; ethylene/acrylic acid copolymer ionomers; ethylene/(meth)acrylic acid copolymer ionomers; and ethylene/(meth)acrylic acid/alkyl acrylates terpolymers.

21. The process of claim 20 wherein the image is printed using a drop on demand ink jet printing process.

22. The process of claim 21 wherein the drop on demand process is a piezo electric process.

23. The process of claim 21 wherein the drop on demand process is a thermal ink jet printing process.

24. The process of claim 23 wherein the thermal ink jet printing process is a continuous drop ink jet printing process.

25. The process of claim 12 wherein the surface roughness (Rz) of the surface of the interlayer sheet that is printed on is between 5 and 15 μm.
